(19) United States
(12) Patent Application Publication
(10) Pub. No.: US 2008/0144476 A1
(43) Pub. Date: Jun. 19, 2008

(54) OPTICAL PICKUP APPARATUS AND PHOTODETECTOR

(75) Inventor: Tomiyuki Numata, Mihara-shi (JP)

Correspondence Address: MORRISON & FOERSTER LLP, 1650 TYSONS BOULEVARD, SUITE 400, MCLEAN, VA, 22102, US

(73) Assignee: SHARP KABUSHIKI KAISHA, Osaka-shi (JP)

(21) Appl. No.: 11/952,285

(22) Filed: Dec. 7, 2007

(30) Foreign Application Priority Data
Dec. 15, 2006 (JP) 2006-339214

(51) Int. Cl. G11B 7/00

(52) U.S. Cl. 369/121

(57) ABSTRACT

A first photodiode for BD receives a laser light beam separated from a laser light beam emitted from a first semiconductor laser, detects laser power of the first semiconductor laser, and outputs an output current signal. A second photodiode for DVD/CD receives a laser light beam separated from a laser light beam emitted from a second semiconductor laser, detects laser power of the second semiconductor laser, and outputs an output current signal. An output terminal of the first photodiode and an output terminal of the second photodiode are connected to each other, and the output current signal and the output current signal are both inputted to the same input terminal of the first current-voltage conversion circuit.

### CROSS-REFERENCE TO RELATED APPLICATION

This application claims priority to Japanese Patent Application No. 2006-339214, which was filed on Dec. 15, 2006, the contents of which are incorporated herein by reference in its entirety.

### BACKGROUND OF THE INVENTION

1. Field of the Invention

The present invention relates to an optical pickup apparatus capable of performing recording and reproducing information on or from an information recording medium and also relates to a photodetector for the same. More specifically, the invention relates to an optical pickup apparatus which performs recording or reproducing information on or from different types of optical discs by use of a plurality of semiconductor laser devices which emit light of different wavelengths. Particularly, the invention relates to an optical pickup apparatus in which output power of a plurality of semiconductor laser devices can be controlled by use of a single circuit, and a photodetector designed for use in the optical pickup apparatus.

2. Description of the Related Art

There has been hitherto known an optical disc apparatus as an apparatus capable of recording and reproducing a large volume of information. In the optical disc apparatus, an optical pickup apparatus (hereinafter, occasionally referred to as an “optical pickup” simply) which records or reproduces information, is provided with a semiconductor laser device (hereinafter, occasionally referred to as a “semiconductor laser” simply) which serves as a light source.

In the optical disc apparatus, recording and reproducing information is carried out by irradiating an optical disc with laser light from the semiconductor laser. In reproducing information in the optical disc apparatus, laser light of a predetermined power from the light source of the optical pickup is focused on the optical disc and a pit formed on the optical disc is detected, whereby information recorded on the optical disc is read out. In recording information, a semiconductor laser emits light of a power higher than the power employed at the time of reproducing information. And simultaneously, the optical pickup modulates output power (hereinafter, occasionally referred to as “laser power”) in accordance with information to be recorded, and forms a pit on the optical disc.

In order to record and reproduce information with high quality, it is necessary to control laser power for recording information and reproducing information. Generally, optical output of a semiconductor laser is susceptible to influence of temperature. Accordingly, amount of laser light emission which the optical disc is irradiated with is controlled so that a predetermined amount of laser light is maintained.

In the optical pickup, a light-detecting element such as a photodiode receives part of laser light emitted from the semiconductor laser, and an output current signal of the photodiode is converted into a voltage signal by a current-voltage conversion circuit. In this state, a control for optimizing the output power is performed by detecting an output power of the semiconductor laser as a voltage signal and giving feedback thereafter to a semiconductor laser driving circuit.

An optical pickup which can record or reproduce information on or from a plurality of types of optical discs using a single optical pickup, has been achieved. For example, an optical pickup applicable to two types of optical discs, namely Compact Disc (CD) and Digital Versatile Disc (DVD), has been realized, and the optical pickup is loaded by an infrared semiconductor laser and a red semiconductor laser. For such an optical pickup where are loaded a plurality of semiconductor lasers, it is necessary to detect output power of the respective semiconductors and control respective levels of launch power thereof, resulting in an increase in both optical elements loaded in the optical pickup and accompanying circuits thereof. Concernedly, this will be obstacle to miniaturization and cost reduction of the optical pickup.

Proposals have been made heretofore to solve the problems as have been described. For example, in an optical apparatus described in Japanese Unexamined Patent Publication JP-A 2002-109771, laser beams from a plurality of laser light sources are guided correspondingly to a plurality of light-receiving elements or light-detecting elements housed into the same package. By doing so, output power of the respective laser light sources is detected. A photocurrent signal representing an output power detected by the respective light-detecting elements, is converted into a voltage signal by a current-voltage conversion circuit with respect to the respective light-detecting elements. The converted voltage is thereafter inputted to common means for controlling amount of light, so that output of the respective semiconductor lasers is controlled. One current-voltage conversion circuit is provided for each of the light-detecting elements. Consequently, laser power is detected by a light-receiving circuit suitable for the respective laser beams, and output of the respective laser light sources is controlled.

In an optical pickup apparatus described in Japanese Unexamined Patent Publication JP-A 2002-319175, light beams from a plurality of light sources are guided to a single photodetector or a single light-detecting element, and output powers of the plurality of light sources are detected by the light-detecting element. This enables reduction in the number of photodetectors and accompanying circuits thereof.

In an optical pickup and an optical disc apparatus described in Japanese Unexamined Patent Publication JP-A 2003-217160, light beams from a plurality of light sources are guided to a single photodetector or a single light-detecting element. The amount of the beams which enter the light-detecting element, is adjusted by moving a light-shielding plate. This enables sensitivity of light detection to be optimized, without using a switch circuit which switches monitor sensitivity of the light-detecting element in accordance with the light sources.

In an information processing apparatus described in Japanese Unexamined Patent Publication JP-A 2004-133987, a plurality of beam-splitters which reflect light beams from a plurality of light sources, are arranged in increasing order of wavelength with respect to an objective lens to differentiate transmittances of polarized light of the beam splitters from each other. This enables high light-efficiency of the optical pickup to be secured, and enables it to be realized to detect output powers of the plurality of light sources by use of the same power detector of light source or the same light-detecting element.

In recent years, types of optical discs have been further diversified, making thereby more complicated an optical system of an optical pickup which record or reproduce information on or from a plurality of types of optical discs. For example, it is preferable to achieve an optical pickup, which responds to Blu-ray Disc (BD) in addition to CD and DVD and is loaded by three semiconductor lasers, namely, an infrared semiconductor laser emitting light of around 780 nm, a red semiconductor laser emitting light of around 650 nm, and a violet-blue semiconductor laser emitting a light of around 405 nm. Further, even for optical discs where the same violet-blue semiconductor lasers are employed, there is a rising demand for achieving an optical pickup to respond to High Definition DVD (HD-DVD) where are employed objective lenses having a numerical aperture (NA) ratio different from objective lenses employed in BD.

In such an optical pickup responding to a plurality of types of optical discs, it is required that information can be recorded or reproduced on or from the respective optical discs with high quality. For this reason, it is required to perform an optimum optical design of respective light paths composed of semiconductor lasers and objective lenses. However, there appear naturally limitations on optical systems for detecting output power of semiconductor lasers. When light beams emitted from a plurality of semiconductor lasers are guided to a single light-detecting element and output power values thereof are attempted to be detected, it is difficult to perform an optimum optical design responding to the plurality of optical discs without deterioration in flexibility of the optical design. In order not to deteriorate the flexibility of the optical design, it is necessary to employ a plurality of light-detecting elements to detect powers of the plurality of semiconductor lasers correspondingly.

Recently, different companies have proposed a semiconductor laser drive large scale integration (LSI) for driving a plurality of semiconductor lasers. At the time of reproducing information, the semiconductor lasers are modulated at high frequency of hundreds of MHz, thereby reducing laser noise thereof. That is to say, radio-frequency superposition is performed. At the time of recording information, the semiconductor lasers are required to be performed a fast modulation of dozens of MHz referred to as write strategy. Simultaneously, power levels thereof are required to be controlled with high precision. This makes it necessary to load the semiconductor laser drive LSI to an optical pickup.

When output powers of a plurality of semiconductor lasers are detected by use of a plurality of light-detecting elements, in addition to the semiconductor laser drive LSI, it is necessary to load accompanying current-voltage conversion circuits, the number of which corresponds to the number of light-detecting elements. This hinders downsizing of the optical pickup. Further, loading many circuit components to the optical pickup causes complication in circuit wirings thereof and undermines high-speed capability of laser-power detection due to floating capacitance of wirings.

In a related technique described in JP-A 2002-109771, there exists the problem that it is necessary to provide a current-voltage conversion circuit for respective light-detecting elements. A single light-detecting element is adopted in related techniques described in JP-A 2002-319175, JP-A 2003-217160, and JP-A 2004-133987. In this way, lights emitted from a plurality of semiconductor lasers are guided to the light-detecting element. However, this causes limitation on optical systems and causes deterioration in flexibility of optical design undesirably.

### SUMMARY OF THE INVENTION

An object of the invention is to provide an optical pickup apparatus and a photodetector that can reduce number of current-voltage conversion circuits necessary for controlling output powers of a plurality of light sources, without deteriorating flexibility of optical design where are employed the plurality of light sources.

The invention provides an optical pickup apparatus which performs at least either recording information on an information recording medium or reproducing information from an information recording medium, comprising:

a plurality of light sources;

a plurality of light-detecting elements which receive light emitted from the light sources, the plurality of light-detecting elements each having an output terminal for outputting a current signal corresponding to an intensity level of the received light; and

a current-voltage conversion circuit having an input terminal for inputting the current signal, the current-voltage conversion circuit converting the current signal inputted to the input terminal into a voltage signal so as to output the voltage signal,

wherein the output terminals of the plurality of light-detecting elements are connected to each other and are connected to the input terminal of the current-voltage conversion circuit.

According to the invention, when performing at least either recording information on the information recording medium or reproducing information from the information recording medium, light beams emitted from a plurality of light sources are received by a plurality of light-detecting elements each having an output terminal, and a current signal corresponding to an intensity of a received light beam is outputted. The current-voltage conversion circuit has an input terminal, and by the current-voltage conversion circuit having an input terminal, the current signal inputted to the input terminal thereof is converted into a voltage signal, which is thereafter outputted. Further, the output terminals of the plurality of light-detecting elements are connected to each other and are connected to the input terminal of the current-voltage conversion circuit. Accordingly, this enables the light-detecting elements to be employed with respect to the respective light sources. Further, without deterioration in the flexibility of optical design, it is possible to reduce the number of the current-voltage conversion circuits necessary for controlling output powers of the plurality of light sources. Here, the number can be reduced to one. Accordingly, it is possible to achieve an optical pickup which is applicable to a plurality of types of optical discs, is downsized, and is reduced in cost, and by which the flexibility in optical design can be secured. Further, in the invention, it is preferable that the plurality of light sources includes:

a first light source which emits light when recording and reproducing information are performed on or from the information recording medium; and

a second light source which emits light when only reproducing information is performed from the information recording medium, the plurality of light-detecting elements includes:

a first light-detecting element which receives the light emitted from the first light source; and

a second light-detecting element which receives the light emitted from the second light source, and the first light-detecting element and the second light-detecting element are arranged in such a manner that a length of a wiring path from an output terminal of the first light-detecting element to the input terminal of the current-voltage conversion circuit is shorter than a length of a wiring path from an output terminal of the second light-detecting element to the input terminal of the current-voltage conversion circuit.

According to the invention, the plurality of light sources include a first light source and a second light source, and the plurality of light-detecting elements include a first light-detecting element which receives the light emitted from the first light source and a second light-detecting element which receives the light emitted from the second light source. The first light source emits light when recording and producing information are performed on or from the information recording medium, and the second light source emits light when only reproducing information is performed from the information recording medium. Further, the first light-detecting element and the second light-detecting element are arranged in such a manner that a length of a wiring path from the output terminal of the first light-detecting element to the input terminal of the current-voltage conversion circuit is shorter than the length of the wiring path from the output terminal of the second light-detecting element to the input terminal of the current-voltage conversion circuit. This makes it possible to reduce waveform rounding of current signal detected on a side where recording and producing information are performed with high speed. Accordingly, output powers of the light sources can be controlled with high accuracy, and information can be recorded or reproduced with high quality.

Further, in the invention, it is preferable that the optical pickup apparatus further comprises:

a high-frequency cut-off element for cutting off a high-frequency signal having a frequency equal to a predetermined frequency value or higher, the plurality of light sources include:

a first light source which emits light when recording and reproducing information are performed on or from the information recording medium; and

a second light source which emits light when only reproducing information is performed from the information recording medium, the plurality of light-detecting elements include:

a first light-detecting element which receives the light emitted from the first light source; and

a second light-detecting element which receives the light emitted from the second light source, and an output terminal of the second light-detecting element is connected, via the high-frequency cut-off element, to an output terminal of the first light-detecting element and the input terminal of the current-voltage conversion circuit.

According to the invention, the optical pickup apparatus further comprises a high-frequency cut-off element, the plurality of light sources include a first light source and a second light source, and the plurality of light-detecting elements include a first light-detecting element which receives the light emitted from the first light source, and a second light-detecting element which receives the light emitted from the second light source. The high-frequency cut-off element is used to cut off a high-frequency signal having a frequency equal to a predetermined frequency value or higher. The first light source emits light when recording and producing information are performed on or from the information recording medium, and the second light source emits light when only reproducing information is performed from the information recording medium. Further, the output terminal of the second light-detecting element is connected, via the high-frequency cut-off element, to both the output terminal of the first light-detecting element and the input terminal of the current-voltage conversion circuit. Consequently, it is possible to prevent deterioration in frequency property of the light-detecting element which operates at high frequency and is located on a side where information is recorded, due to a parasitic capacity of the light-detecting element on a side where a light source is only used for reproducing information. As a result, broadband power detection can be performed and reliability can be improved.

Further, in the invention, it is preferable that the optical pickup apparatus further comprises:

a high-density integrated circuit portion having an input terminal of the current-voltage conversion circuit, the high-density integrated circuit portion including a plurality of driving circuits for driving the plurality of light sources, respectively, and the current-voltage conversion circuit, the plurality of driving circuits and the current-voltage conversion circuit being housed in a same package, and

the input terminal formed in the high-density integrated circuit portion is connected to the respective output terminals of the plurality of light-detecting elements.

According to the invention, the optical pickup apparatus further comprises a high-density integrated circuit portion having an input terminal of the current-voltage conversion circuit, the high-density integrated circuit portion including a plurality of driving circuits for driving the plurality of light sources, respectively, and the current-voltage conversion circuit, the plurality of driving circuits and the current-voltage conversion circuit portion being housed in the same package. Further, the input terminal formed in the high-density integrated circuit portion is connected to the respective output terminals of the plurality of light-detecting elements. Consequently, this makes it possible to use an existing low-price LSI where driving circuits and a current-voltage conversion circuit are housed in the same package. As a result, the costs of the optical pickup apparatus can be reduced.

Further, in the invention, it is preferable that the optical pickup apparatus further comprises:

a photodetector including a light-detecting element and a current-voltage conversion circuit, the light-detecting element and the current-voltage conversion circuit being housed into a same package, the photodetector having an output terminal which outputs a voltage signal converted by the current-voltage conversion circuit; and

a resistance element connected to the output terminal of the photodetector, and

the output terminal of the photodetector is connected via the resistance element to the input terminal formed in the high-density integrated circuit portion.

According to the invention, the optical pickup apparatus further comprises a photodetector and a resistance element. The photodetector is provided with a light-detecting element and a current-voltage conversion circuit which are both housed into the same package. The photodetector also has an output terminal which outputs the voltage signal converted by the current-voltage conversion circuit, and the resistance element is connected to the output terminal of the photodetector arranged in the optical pickup apparatus. Further, the output terminal of the photodetector is connected via the resistance element to the input terminal formed in the high-density integrated circuit portion. Consequently, high-frequency light detection can be performed, thereby enabling fast operation to be achieved. Further, with respect to power detection of the two light sources, power of one light source is detected by use of the photodetector where are molded the light-detecting element and the current-voltage conversion circuit, while power of the other one is detected by use of the current-voltage conversion circuit disposed inside the laser package. As a result, this enables the optical pickup to be downsized and cost reduction to be achieved.

Further, the invention provides a photodetector having an input terminal for inputting an current signal, comprising:

a light-detecting element for receiving light and outputting a current signal corresponding to an intensity of the received light; and

a current-voltage circuit for converting a current signal into a voltage signal and outputting the voltage signal,

the light-detecting element and the current-voltage circuit being housed into a same package,

wherein the current signal outputted from the light-detecting element and the current signal inputted from the input terminal are both inputted to the current-voltage conversion circuit.

Further, according to the invention, in the photodetector having an input terminal for inputting the current signal, a light-detecting element and a current-voltage circuit are housed into the same package. The light-detecting element receives light and thereafter outputs a current signal corresponding to intensity of the received light. The current-voltage circuit converts the current signal to a voltage signal and outputs the voltage signal. Further, the current signal outputted from the light-detecting element and the current signal inputted from the input terminal are both inputted to the current-voltage conversion circuit. Consequently, this enables a high frequency-band light detection, compared to a case where a light-detecting element is used alone without being integrated with a current-voltage conversion circuit. This also makes it possible that the current signal of the light-detecting element used alone can be inputted from the input terminal so as to be subjected to a current-voltage conversion. Accordingly, a single current-voltage conversion circuit is applicable to both a light source of which fast operation is required and a light source of which fast operation is not required. As a result, the photodetector can be downsized. That is to say, without deteriorating the flexibility of optical design where are employed a plurality of light sources, it is possible to reduce the number of circuit-voltage conversion circuits necessary for controlling output powers of the plurality of light sources.

### BRIEF DESCRIPTION OF THE DRAWINGS

Other and further objects, features, and advantages of the invention will be more explicit from the following detailed description taken with reference to the drawings wherein:

FIG. 1 is a schematic block diagram showing an optical pickup according to a first embodiment of the invention;

FIG. 2 is a view showing an example of circuit constitution composed of a first photodiode, a second photodiode, and a first current-voltage conversion circuit which are shown in FIG. 1;

FIG. 3 is a schematic block diagram showing an optical pickup according to a second embodiment of the invention;

FIG. 4 is a view showing a layout of the optical pickup shown in FIG. 3;

FIG. 5 is a view showing an example of circuit constitution composed of a first photodiode, a second photodiode, a coil, and a first current-voltage conversion circuit which are shown in FIG. 3;

FIG. 6 is a schematic block diagram showing an optical pickup according to a third embodiment of the invention;

FIG. 7 is a view showing an example of circuit constitution composed of a first photodiode, a third photodiode, and a semiconductor laser driving LSI and the like;

FIG. 8 is a view showing an example of circuit constitution where the first photodiode shown in FIG. 7 is replaced with a fourth photodetector; and

FIG. 9 is a view showing a schematic constitution of a fifth photodetector according to one embodiment of the invention.

### DETAILED DESCRIPTION

Now referring to the drawings, preferred embodiments of the invention are described below.

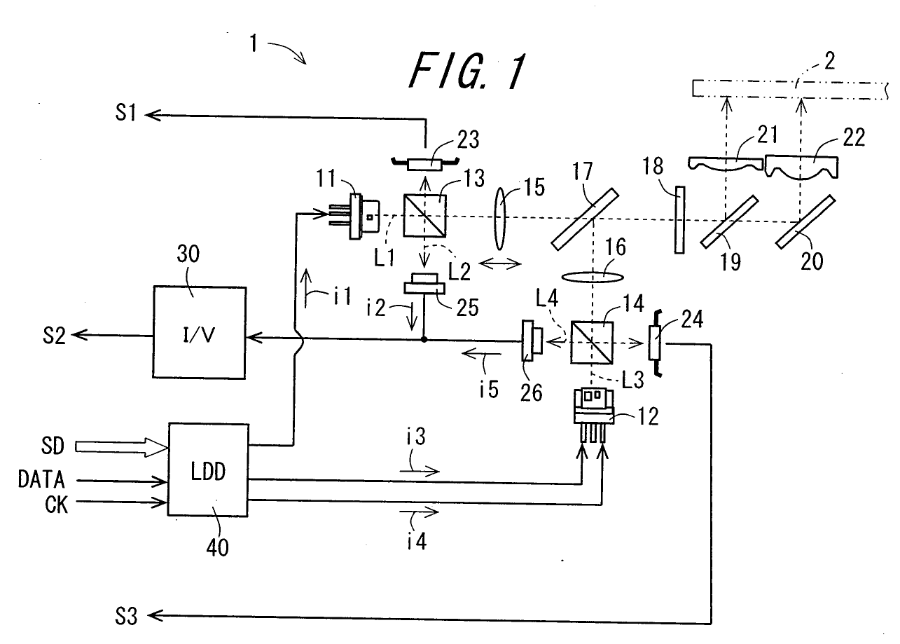

FIG. 1 is a schematic block diagram of an optical pickup 1 according to a first embodiment of the invention. In the optical pickup 1 which is an optical pickup apparatus, an optical disc 2 that is an information recording medium is irradiated with laser light, for the sake of recording and reproducing information. The optical pickup 1 may be so configured as to allow only one of recording information and reproducing information to be performed. The optical disc 2, for example, is one selectable from a group including Blu-ray Disc (BD). Compact Disc (CD), and Digital Versatile Disc (DVD).

In the present embodiment, description is given to a three-wavelength pickup responding to three types of standard optical discs, but it is not limited thereto. A two-wavelength pickup responding to two types of standard optical discs may also be employed. For example, as in the case of BD and HD-DVD (High Definition DVD), an optical pickup where are employed two semiconductor lasers having the same blue-violet wavelength, may also be used. In respective types of optical discs such as BD, HD-DVD, DVD, CD, or the like, there are discs from which information is only reproduced, discs on which information can be recorded repeatedly, or discs on which information can be recorded only once, or the like. Any type of discs thereof may be used. Further, magneto-optical discs such as Mini Disc (MD) or the like may also be used.

The optical pickup 1, for example, is a three-wavelength pickup which emits laser light having three wavelengths. The optical pickup 1 comprises a first semiconductor laser 11, a second semiconductor laser 12, a first beam splitter 13, a second beam splitter 14, a first collimating lens 15, a second collimating lens 16, a dichroic mirror 17, a λ/4 plate 18, a first upward-directing mirror 19, a second upward-directing mirror 20, a first objective lens 21, a second objective lens 22, a first photodetector 23, a second photodetector 24, a first photodiode 25, a second photodiode 26, a first current-voltage conversion circuit (abbreviated as “I/V” in FIG. 1) 30, and a semiconductor laser driving circuit (abbreviated as “LDD” in the drawings) 40. FIG. 1 is a schematic block diagram for describing one embodiment of the invention. Therefore, in FIG. 1, parts are omitted that are not directly related to the embodiment of the invention, such as an optical system for detecting a servo signal.

The first semiconductor laser 11 emits blue-violet laser light of around 405 nm and is used for recording and reproducing information on or from BD. The second semiconductor laser 12 is a two-wavelength laser which emits infrared laser light of around 780 nm and red laser light of around 650 nm. The second semiconductor laser 12 is used for recording and reproducing information on or from CD or DVD. The first semiconductor laser 11 is driven by the semiconductor laser driving circuit 40, and emits laser light beams L1 thereof in a direction of the first beam splitter 13. The second semiconductor laser 12 is driven by the semiconductor laser driving circuit 40, and emits laser light beams L3 in a direction of the second beam splitter 14. In the second semiconductor laser 12, in order to differ slightly a position of luminous point of a laser light beam for recording and reproducing information on or from DVD from that of a laser light beam for recording and reproducing information on or from CD, optical axes of the two emitted laser light beams thereof are designed to be actually different from each other. However, a common optical axis is drawn in FIG. 1 to represent the optical axes of the two emitted laser beams, for the sake of simplifying the description.

The first beam splitter 13 splits the laser light beam L1 emitted from the first semiconductor laser 11 and reflects a part of the laser light beam L1 in a direction of the first photodiode 25. The rest of the laser light beam L1 emitted from the first semiconductor laser 11 go straight and head in a direction of the first collimating lens 15. Furthermore, a reflected light beam of the laser light beam L1, which has returned through being reflected by the optical disc 2, is reflected in a direction of the first photodetector 23. The second beam splitter 14 splits the laser light beam L3 emitted from the second semiconductor laser 12 and reflects a part of the laser light beam L3 in a direction of the second photodiode 26. The rest of the laser light beam L3 emitted from the second semiconductor laser 12 go straight and head in a direction of the second collimating lens 16. Furthermore, a reflected light beam of the laser light beam L3, which has returned through being reflected by the optical disc 2, is reflected in a direction of the second photodetector 24.

The first collimating lens 15 collimates substantially the light beam, which is emitted from the first semiconductor laser 11 and thereafter transmitted through the first beam splitter 13. Inversely, the first collimating lens 15 converges the reflected light beam returning from the optical disc 2 on the first photodetector 23. The second collimating lens 16 collimates substantially the light beam, which is emitted from the second semiconductor laser 12 and thereafter transmitted through the second beam splitter 14. Inversely, the second collimating lens 16 converges the reflected light beam returning from the optical disc 2 on the second photodetector 24. By moving the first collimating lens 15 or the second collimating lens 16 in the direction of respective optical axes thereof, compensation can be made on aberration of beam spot formed on the optical disc 2.

The dichroic mirror 17 has a wavelength-selective property, and thereby is used to separate and/or synthesize a light path of BD system and a light path of DVD/CD system. To be specific, on one hand, the dichroic mirror 17 transmits light of BD light path, that is, the laser light beam L1 emitted from the first semiconductor laser 11 and the reflected light beam thereof. And on the other hand, the dichroic mirror 17 reflects a light beam of DVD/CD light path, that is, the laser light beam L3 emitted from the second semiconductor laser 12 and the reflected light beam thereof.

The λ/4 plate 18 converts laser light into circularly-polarized light so as to separate light paths on an approach path and a return path in a polarization optical system. By converting the laser light into the circularly-polarized light by the λ/4 plate, it is possible to reduce birefringence influence of optical discs. The λ/4 plate is arranged between the dichroic mirror 17 and the first upward-directing mirror 19 in the present embodiment, but it may be arranged in both a BD system and a DVD/CD system. That is to say, the λ/4 plate may be arranged between the second upward-directing mirror 20 and the second objective lens 22, or between the first upward-directing mirror 19 and the first objective lens 21.

The first upward-directing mirror 19, the same as the dichroic mirror 17, has a wavelength-selective property. The first upward-directing mirror 19 transmits the laser light beam L1 emitted from the first semiconductor laser used in BD and the reflected light beam thereof, and reflects the laser light beam L3 emitted from the second semiconductor laser 12 used in DVD/CD and the reflected light beam thereof. In contrast, the second upward-directing mirror 20 reflects the laser light beam L1 and the reflected light beam thereof.

The first objective lens 21 converges the laser light beam L3 on a surface of the optical disc 2, and collimates substantially reflected light from the optical disc 2 inversely. The second objective lens 22 converges the laser light L1 on the surface of the optical disc 2, and collimates substantially reflected light from the optical disc 2 inversely. The first objective lens 21 is a bifocal lens and responds to both DVD and CD. An objective lens having a numerical aperture (NA: Numerical Aperture) ratio of about 0.85 is adopted as the second objective lens 22 used in BD.

The first photodetector 23 converts photoelectrically the reflected light which is reflected by the optical disc 2 and returns thereafter on a light path of BD system, into a reproduced signal S1. The second photodetector 24 converts photoelectrically the reflected light which is reflected by the optical disc 2 and returns thereafter on the optical path of DVD/CD system, into a reproduced signal S3. The reproduced signal S1 and the reproduced signal S3 are both outputted to the outside of the optical pickup 1.

The first photodiode 25 which is a light-detecting element, receives the laser light beam L2, which is a part of the laser light beam L1 emitted from the first semiconductor laser 11 and which is split and reflected by the first beam splitter 13. The first photodiode 25 thereby detects laser power, that is, a light intensity of the first semiconductor laser 11, and outputs an output current signal i2. The output current signal i2 is thereafter inputted to the first current-voltage conversion circuit 30. The second photodiode 26 which is a second light-detecting element, receives a laser light beam L4, which is a part of the laser light beam L3 emitted from the second semiconductor laser 12 and which is split and reflected by the second beam splitter 14. The second photodiode 26 thereby detects laser power of the second semiconductor laser 12 and outputs an output current i5. The output current i5 is thereafter inputted to the first current-voltage conversion circuit 30. The second photodiode 26 is so configured as to detect both laser power for DVD and laser power for CD. An output terminal of the first photodiode 25 and an output terminal of the second photodiode 26 are connected to each other, and both are connected together to the same input terminal of the first current-voltage conversion circuit 30.

When the first semiconductor laser 11 emits light, the detected current i2 of the first photodiode 25 is inputted therefrom to the first current-voltage conversion circuit 30. When the second semiconductor laser 12 emits light, the detected current i5 of the second photodiode 26 is inputted therefrom to the first current-voltage conversion circuit 30. Any one among BD, DVD, and CD may be adopted as the optical disc 2 where recording and reproducing information are performed by the optical pickup 1. In normal operations, there is no such a case where the first semiconductor laser 11 and the second semiconductor laser 12 emit light simultaneously.

The first current-voltage conversion circuit 30 is a circuit for converting a current signal into a voltage signal S2. The current signal is either the output current i2 inputted from the first photodiode 25 or the output current i5 inputted from the second photodiode 26. The voltage signal S2 is outputted to the outside of the optical pickup 1 and is further inputted to a non-illustrated control circuit arranged in the optical disc apparatus. For the sake of maintaining power of the beam L1 emitted on the optical disc 2 from the first semiconductor laser 11 or the beam L3 emitted on the optical disc 2 from the second semiconductor laser 12, to be a predetermined value, feedback control referred generally to as an automatic power control (APC) is performed on the semiconductor laser driving circuit 40 in the control circuit. The APC function may be provided inside the semiconductor laser driving circuit 40. In this way, it is possible to constitute a feedback control loop inside the optical pickup 1.

From the aforementioned non-illustrated control circuit arranged in the optical disc apparatus, the semiconductor laser driving circuit 40 receives a setting signal SD, a data signal DATA which is a signal of to-be-recorded information, and a clocking signal CK. The signal SD is used for setting output power or laser power as well as for setting a power modulation system referred to as write strategy. When recording and reproducing information are performed on or from BD, the semiconductor laser driving circuit 40 supplies the current signal i1 to the first semiconductor laser 11 on the basis of the SD, DATA, and CK signals so as to make the first semiconductor 11 emit light. That is to say, the semiconductor laser driving circuit 40 supplies the first semiconductor laser 11 with the pulsed current i1 corresponding to information to be recorded on the optical disc 2. In this way, light emitted from the first semiconductor laser 11 is modulated to a recording-light pulse shape. Similarly, when recording and reproducing information are performed on or from DVD, the semiconductor laser driving circuit 40 supplies a current signal i3 to the second semiconductor laser 12 on the basis of the SD, DATA, and CK signals so as to make the second semiconductor laser 12 emit light. When recording and reproducing information on or from CD, the semiconductor laser driving system supplies a current signal i4 to the second semiconductor laser 12 on the basis of the SD, DATA, and CK signals, so as to make the second semiconductor laser 12 emit light.

An operation of the optical pickup 1 at the time of recording information on the optical disc 2, is substantially the same as an operation at the time of reproducing information from the optical disc 2. When recording and reproducing information are performed on or from BD, the beam L1 emitted from the first semiconductor laser 11 passes through an optical system including the first beam splitter 13, the first collimating lens 15, the dichroic mirror 17, the λ/4 plate 18, the first upward-directing mirror 19, the second upward-directing mirror 20, and the second objective lens 22, and leads to the optical disc 2. The reflected light beam of the beam L1 reflected by the optical disc 2, passes through the second objective lens 22, the second upward-directing mirror 20, the first upward-directing mirror 19, the λ/4 plate 18, the dichroic mirror 17, the collimating lens 15, and the first beam splitter 13 in the order named, and enters the first photodetector 23. Further, a part of the beam L1 emitted from the second semiconductor laser 12 is reflected concurrently by the first beam splitter 13. The reflected part of the beam L1 is thereafter detected by the first photodiode 25.

When recording and reproducing information are performed on or from DVD/CD, the beam L3 emitted from the second semiconductor laser 12, passes through an optical system including the second beam splitter 14, the second collimating lens 16, the dichroic mirror 17, the λ/4 plate 18, the first upward-directing mirror 19, the second upward-directing mirror 20, and the first objective lens 21, and leads to the optical disc 2. The reflected light beam of the beam L2 reflected by the optical disc 2, passes through the first objective lens 21, the first upward-directing mirror 19, the λ/4 plate 18, the dichroic mirror 17, the second collimating mirror 16, and the second beam splitter 14 in the order named, and enters the second photodector 24. Further, a part of laser light beam L3 emitted from the second semiconductor laser 12 is reflected concurrently by the first beam splitter 12. And, the reflected part of the beam L3 thereof is detected thereafter by the second photodiode 26.

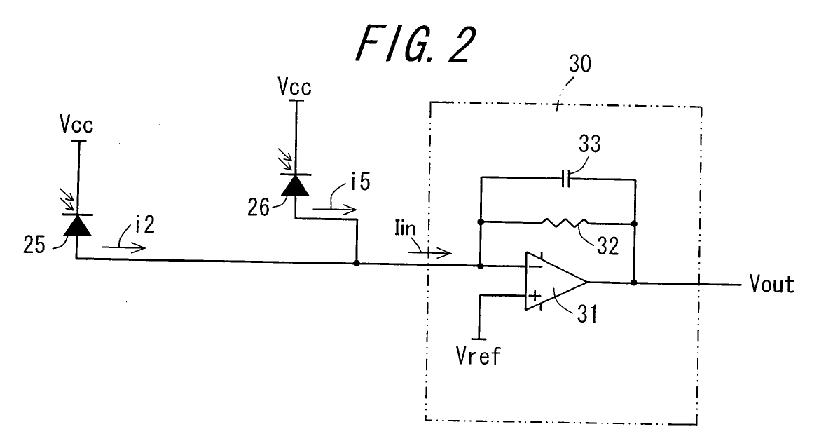

FIG. 2 is a view showing an example of circuit constitution composed of the first photodiode 25, the second photodiode 26, and the first current-voltage conversion circuit 30 which are shown in FIG. 1. A supply voltage Vcc is applied to respective cathode terminals of the first photodiode 25 and the second photodiode 26, thereby making the first photodiode 25 and the second photodiode 26 inversely-biased. Generally, biasing a photodiode inversely improves a high-speed capability thereof. Anode terminals of the first photodiode 25 and the second photodiode 26 are connected to each other, and both are connected to the input terminal of the first current-voltage conversion circuit 30. In this way, the output current i2 of the first photodiode 25 and the output current i5 of the second photodiode 26 are inputted to the first current-voltage conversion circuit 30.

The first current-voltage conversion circuit 30 is composed of a first operational amplifier 31, a first resistor 32, and a capacitor 33. With respect to two terminals of the first resistor 32, one is connected to an inverting input terminal of the first operational amplifier 31, and the other one is connected to an output terminal of the first operational amplifier 31. A reference voltage V_{ref} is applied to a non-inverting input terminal of the first operational amplifier 31. The capacitor 33 is connected in parallel to the first resistor 32. The capacitor 33 plays roles of attenuating a component of signal within a high frequency-band and stabilizing a circuit operation. However, when the operation of the first operational amplifier 31 is stable, the capacitor 33 is not indispensable.

A relationship between an input current Iᵢₙ and an output voltage Vₒᵤₜ of the first current-voltage conversion circuit 30 is expressed by the following equation:

Vₒᵤₜ=V_{ref}−Iᵢₙ×R1

wherein R1 is a value of the first resistor 32.

As mentioned above, there is no the case where laser light for power detection simultaneously enters both the first photodiode 25 and the second photodiode 26. Consequently, the input current Iᵢₙ of the first current-voltage conversion circuit 30 is substantially equal to either the output current i2 of the first photodiode 25 or the output current i5 of the second photodiode 26.

It is known that a current referred to as a dark current slightly flows through a photodiode, even when no light enters the photodiode. Further, a tiny current can pass through the photodiode, by exposing the photodiode, for example, to light other than the laser light for power detection, that is, the so-called stray light. Here, the stray light includes light from the outside of the pickup. Further, the stray light also includes light which is part of outgoing light from the semiconductor laser 12 and thereafter enters the first photodiode 25, or which is part of outgoing light from the first semiconductor laser 11 and thereafter enters the second photodiode 26. In this case, error occurs between the output of the first current-voltage conversion circuit 30 and laser power to be detected, so an offset adjustment function for compensating the error may be provided in the first current-voltage conversion circuit 30. When the offset adjustment function is provided in the first current-voltage conversion circuit 30, a scale of the circuit thereof becomes large, thereby inhibiting the optical pickup 1 from being downsized. As a result, it is preferable that the error is corrected by an optical disc apparatus after being outputted from the optical pickup 1.

The non-inverting input terminal of the first operational amplifier 31 is generally connected to the voltage Vref via a resistor so as to compensate an offset produced due to a bias current. Here, however, the resistor is omitted to simply the description.

As has been mentioned, laser power of the first semiconductor laser 11 and laser power of the second semiconductor laser 12 are detected respectively by two different photodiodes, that is, the first photodiode 25 and the second photodiode 26. Therefore, it is unnecessary to guide light of the first semiconductor laser 11 and light of the second semiconductor laser 12 on a common spot. Accordingly, flexibility in designing the optical pickup 1 can be improved, and a highly reliable optical pickup can be achieved. At the same time, the output terminal of the first photodiode 25 and the output terminal of the second photodiode 26 are connected to each other and both are inputted to the same first current-voltage conversion circuit 30. Consequently, the number of the first current-voltage conversion circuits 30 may be one, whereby the circuit thereof can be downsized and number of signal lines of the optical pickup 1 can be reduced. Accordingly, it is possible to achieve downsizing and cost reduction of the optical pickup.

That is to say, when performing at least either recording or reproducing information with respect to an information recording medium such as the optical disc 2, the optical pickup includes a plurality of light sources such as the first semiconductor laser 11 and the second semiconductor laser 12, a plurality of light-detecting elements each having an output terminal such as the first photodiode 25 and the second photodiode 26, and a current-voltage conversion circuit having an input terminal such as the first current-voltage conversion circuit 30. The plurality of light-detecting elements receive light emitted from the plurality of light sources, and output a current signal corresponding to the received light intensity or laser power thereafter. By means of the current-voltage conversion circuit, the current signal inputted to the input terminal thereof is converted into a voltage signal so as to be outputted. Further, the respective output terminals of the plurality of light-detecting elements are connected to each other and are further inputted to the input terminal of the aforementioned current-voltage conversion circuit. Therefore, it is possible to employ the light-detecting elements for each of the light sources. It is also possible to reduce the number of necessary current-voltage conversion circuit for controlling output power of the plurality of light sources, to one, without deterioration in flexibility of optical design. Accordingly, it is possible to achieve an optical pickup which is applicable to a plurality of types of optical discs, is downsized, and is reduced in cost, and by which the flexibility in optical design can be secured.

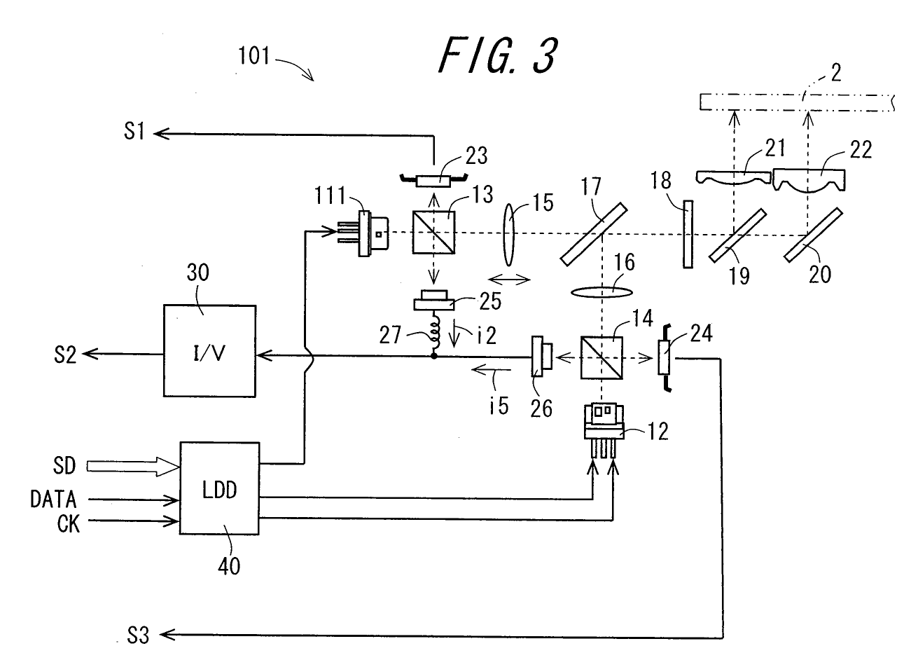

FIG. 3 is a schematic block diagram of an optical pickup 101 according to a second embodiment of the invention. The optical pickup 101 has basically the same constitution as the optical pickup 1 shown in FIG. 1, except that a coil 27 is added and the first semiconductor laser 11 is replaced with a third semiconductor laser 111. Constituent components of the pickup 111 having corresponding components in the optical pickup 1 shown in FIG. 1 will be denoted by the same reference numerals, and overlapping descriptions thereof will be omitted.

The optical pickup 101 performs recording information on and reproducing information from CD and DVD. However, the optical pickup 101 only performs reproducing information from BD, resulting in that a low-power semiconductor laser is employed as the third semiconductor laser 111. The coil 27 is a high-frequency cut-off element for cutting off a predetermined frequency, for example, a high-frequency signal equal to 100 MHz or higher. The coil 27 is connected between the output terminal of the first photodiode 25 and the input terminal of the first current-voltage conversion circuit 30.

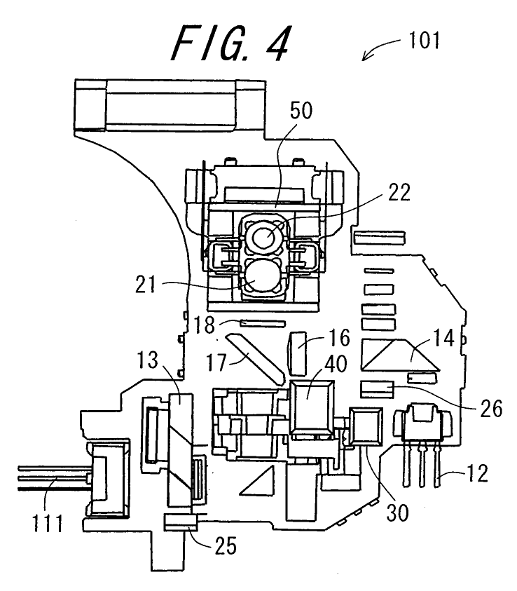

FIG. 4 is a view showing a layout of the optical pickup 101 shown in FIG. 3. The view is a view for explaining, in a state where the optical pickup 101 is assembled, relationships of arranged positions among the first photodiode 25, the second photodiode 26, the first current-voltage conversion circuit 30 and the like.

The first objective lens 21 and the second objective lens 22 are provided in an actuator 50 which displaces positions of the two objective lenses. The first current-voltage conversion circuit 30 and the semiconductor laser driving circuit 40 are soldered on a non-illustrated circuit board so as to be loaded thereon. To the circuit board is connected a wiring board referred to as a flexible printed circuit (FPC). Signals from the optical pickup 101 are inputted to the circuit board. The FPC may be employed as the circuit board per se.

When information is recorded on the optical disc 2, it is necessary for the semiconductor laser driving circuit 40 to change fast a current supplied to the second semiconductor laser 12. Accordingly, the semiconductor laser driving circuit 40 is arranged near to the second semiconductor laser 12 so as not to produce rounding to an optical waveform at the time of recording information. The wiring between the semiconductor laser driving circuit 40 and the second semiconductor 12 thereof is designed to be as short as possible. Similarly, the second photodiode 26 which detects laser power of the second semiconductor laser 12, is also required to have a high-speed capability. Accordingly, the second photodiode 26, and the first current-voltage conversion circuit 30 that converts an output current signal of the second photodiode 26 to a voltage signal, are arranged near to each other. The wiring between thereof are so designed as to be as short as possible.

The first photodiode 25 detects only certain power of the third semiconductor laser 111 at the time of reproducing information, so it is not necessary to arrange the photodiode 25 near to the first current-voltage conversion circuit 30. In a word, in the second embodiment of the invention, the first current-voltage conversion circuit 30 is arranged near to the second photodiode 26, compared with the first photodiode 25.

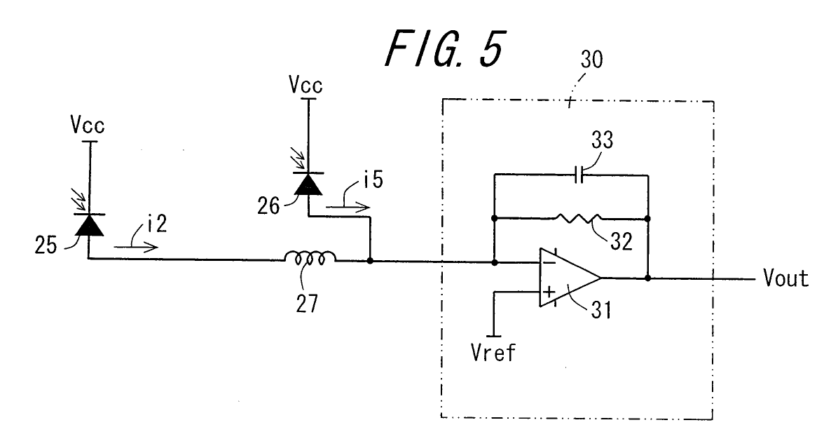

FIG. 5 is a view showing an example of circuit constitution composed of the first photodiode 25, the second photodiode 26, the coil 27, and the first current-voltage conversion circuit 30 which are shown in FIG. 3. The circuit constitution shown in FIG. 5 has basically the same constitution as the circuit constitution in FIG. 2, except that the coil 27 is added.

The anode terminal of the first photodiode 25 is connected to the coil 27, and is further connected mutually to the anode terminal of the second photodiode 26 via the coil 27. A terminal, connected to the anode terminal of the second photodiode 26, of the coil 27 is connected to the inverting input terminal of the operational amplifier 31 of the first current-voltage conversion circuit 30. That is to say, the coil 27 is connected between the anode terminal of the first photodiode 25 and the inverting input terminal of the first operational amplifier 31. The coil 27 and the anode terminal of the second photodiode 26 are connected to each other on a side where the input terminal of the first current-voltage conversion circuit 30 is located.

The first photodiode 25 is separated off from the second photodiode 26 and the first current-voltage conversion circuit 30 with respect to a high-frequency signal. The output current i5 of the second photodiode 26 changes fast at the time of recording information, for example, at a level of approximately dozens of MHz. The coil 27 is provided so as to prevent a high-frequency current from being passed through the first photodiode 25. A high-frequency band which the coil 27 cuts off is so provided as to cut off noise components at a frequency equal to 100 MHz or higher which is generated by an operation for recording information, for example. It is necessary to arrange the coil 27 near to both the first current-voltage conversion circuit 30 and the second photodiode 26. There exists parasitic capacity on the wiring from the first photodiode 25 and the second photodiode 26 to the current-voltage conversion circuit 30. In the case where the coil 27 is not provided, the parasitic capacity hampers a high-speed capability of the output current i5 of the second photodiode 26. Providing the coil 27 can prevent deterioration in high-frequency property of the second photodiode 26. In the second embodiment of the invention, the coil 27 is employed as a high-frequency cut-off element. However, ferrite beads, high-frequency cut-off elements referred to as an impeder, or the like, may be used.

As has been mentioned above, near to the first current-voltage conversion circuit 30 is arranged the second photodiode 26 which detecting power of the second semiconductor laser 12 for performing both recording information and reproducing information. Further, the first photodiode 25 which detects power of the third semiconductor laser 111 for performing only reproducing information, is separated off from the second photodiode 26 and the first current-voltage conversion circuit 30 via the coil 27 with respect to a high-frequency signal. Accordingly, this makes it possible to detect, by using a simple circuit in a wide band without deterioration in high-speed capability, power of the second semiconductor laser 12 for performing recording information. Also, a highly reliable optical pickup can be achieved.

That is to say, the aforementioned plurality of light sources include a first light source such as the second semiconductor laser 12, and a second light source such as the third semiconductor laser 111, wherein the first light source emits light when recording and reproducing information with respect to an information recording medium such as the optical disc 2 are performed, and the second light source emits light when only reproducing information from an information recording medium is performed. And the aforementioned plurality of light-detecting elements include a first light-detecting element such as the second photodiode 26, and a second light-detecting element such as the first photodiode 25, wherein the first light-detecting element receives light emitted from the first light source, and the second light-detecting element receives light emitted from the second light source. Further, the first light-detecting element and the second light-detecting element are arranged in such a manner that a length of a wiring path from an output terminal of the first light detecting element to an input terminal of the aforementioned current-voltage conversion circuit such as the first current-voltage conversion circuit 30, is shorter than a length of a wiring path from an output terminal of the second light-detecting element to the input terminal of the aforementioned current-voltage conversion circuit. Therefore, it is possible to reduce waveform rounding of the current detected on a side where recording and producing information are performed fast. Accordingly, output power can be controlled with high accuracy, and information can be recorded or reproduced with high quality.

Further, the coil 27 serving as a high-frequency cut-off element for cutting off high-frequency signals with a predetermined frequency or higher, is included. And then, a first light source such as the second semiconductor laser 12 and a second light source such as the third semiconductor laser 111 are included, wherein the first light source emits light when recording and reproducing information with respect to an information recording medium such as the optical disc 2 are performed, and the second light source emits light when only reproducing information from an information recording medium is performed. And also, the aforementioned plurality of light-detecting elements include a first light-detecting element such as the second photodiode 26, and a second light-detecting element such as the first photodiode 25, wherein the first light-detecting element receives light emitted from the first light source, and the second light-detecting element receives light emitted from the second light source. Further, an output terminal of the second light-detecting element is connected, via the aforementioned high-frequency cut-off element, to an output terminal of the first light-detecting element and an output terminal of the aforementioned current-voltage conversion circuit such as the first current-voltage conversion circuit 30. Consequently, it is possible to prevent deterioration in a frequency property of a light-detecting element which operates at high frequency and is located on a side where information is recorded, due to a parasitic capacity of a light-detecting element located on the side of a light source used only for reproducing information. Accordingly, power detection can be performed in a wide band and reliability can be improved.

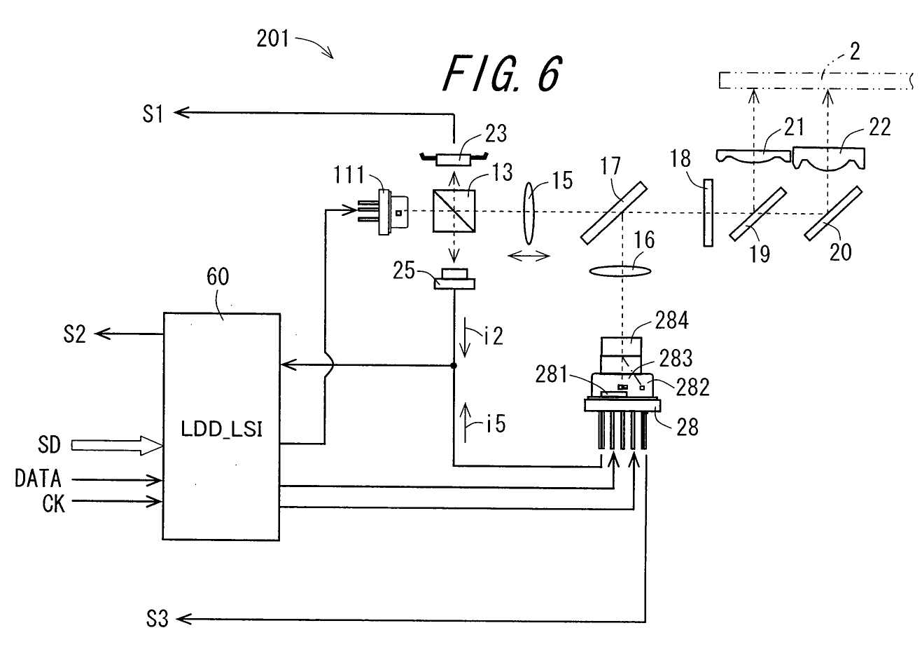

FIG. 6 is a schematic view of an optical pickup 201 according to a third embodiment of the invention. The optical pickup 201 which is an optical pickup apparatus, is constituted basically by replacing the first current-voltage conversion circuit 30 and the semiconductor laser driving circuit shown in the optical pickup 1 of FIG. 1, with a semiconductor laser drive large scale integration (LSI). However, in third embodiment, in order to show diversity of embodiments, the second semiconductor laser 12, the second beam splitter 14, the second photodetector 24, and the second photodiode 26 which are used in DVD/CD, are replaced with a modularized fourth semiconductor laser 28. Constituent components of the pickup 201 having corresponding components in the optical pickup 1 shown in FIG. 1 will be denoted by the same reference numerals, and overlapping descriptions will be omitted.

The fourth semiconductor laser 28 is a hologram laser obtained by modularizing a third photodiode 281 which detects power of a semiconductor laser device 283, a third photodetector 282 which detects a reproduced signal or a servo signal, the semiconductor laser device 283 which emits laser light having two wavelengths, and a hologram optical element 284 which separates laser light.

Laser light emitted from the semiconductor laser device 283 passes through the hologram optical element 284 and heads for the optical disc 2. The reflected light thereof from the optical disc 2 is diffracted by the hologram optical element 284 and enters the third photodetector 282, and then a reproduced signal S3 is outputted therefrom. Power detection of the semiconductor laser device 283 is different from that of the example shown in FIG. 1. Here, power of the light emitted from the back of the semiconductor laser device 283 is detected by means of the third photodiode 281, that is, so-called back monitor.

The semiconductor laser driving LSI 60 comprises a current-voltage conversion circuit and a semiconductor laser driving circuit, and can convert a current signal to a voltage signal and drive three types of semiconductor lasers selectively.

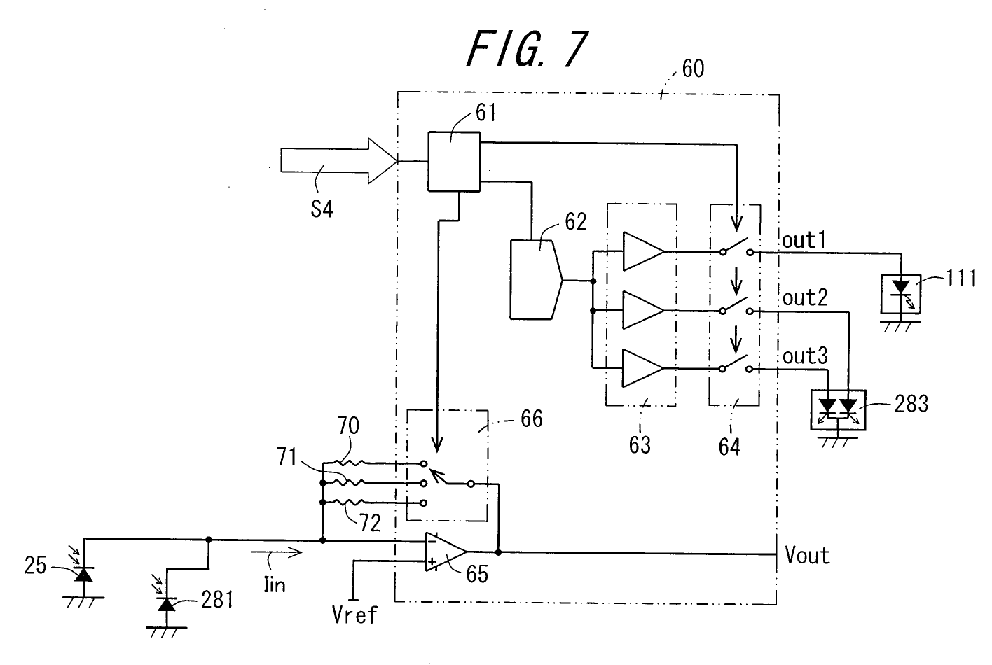

FIG. 7 is a view showing an example of circuit constitution composed of the first photodiode 25, the third photodiode 281, and the semiconductor driving LSI 60 which are shown in FIG. 6. The semiconductor laser drive LSI 60 comprises an interface circuit 61, a digital/analog conversion circuit 62, a driving current source 63, a first switch circuit 64, a third operational amplifier 65, and a second switch circuit 66. The interface circuit 61 receives control signals from the outside of the pickup 201, for example, a setting signal SD, a data signal DATA, and a clock signal CK which are shown in FIG. 6. Also, the interface circuit 61 controls the digital/analog conversion circuit 62, the driving current source 63, the first switch circuit 64, and the second switch circuit 66.

The semiconductor laser drive LSI 60 comprises the semiconductor laser driving circuit which can drive three types of semiconductor lasers selectively. The semiconductor laser driving circuit is composed of the digital/analog conversion circuit 62, the driving current source 63, and the first switch circuit 64. The digital/analog conversion circuit 62 converts a digital signal from the interface circuit 61 into an analog signal, and inputs thereafter the analog signal to the driving current source 63. The driving current source 63 amplifies the inputted analog signal so as to output the analog signal therefrom, via the first switch circuit 64, to any one of output terminals including an output terminal out1 of a first driving current, an output terminal out2 of a second driving current, an output terminal out3 of a third driving current. The first switch circuit 64 is configured by, for example, a semiconductor switch of a field-effect transistor, and turns on one of three switches thereof. The output terminal out1 of the first driving current is connected to the third semiconductor laser 111, while the output terminal out2 of the second driving current and the output terminal out3 of the third driving current are connected to the semiconductor laser device 283 of the fourth semiconductor laser 28. According to a control signal S4 inputted to the semiconductor laser drive LSI 60, the first switch circuit 64 is controlled via a serial interface, and a semiconductor laser to be driven is selected. The control signal S4 is, for example, the setting signal SD, the data signal DATA, and the clock signal CK which are shown in FIG. 6.

Further, the semiconductor laser drive LSI 60 comprises the current-voltage conversion circuit which converts an output current signal of a power-detection photodiode into a voltage signal. The current-voltage conversion circuit is composed of the third operational amplifier 65 and the second switch circuit 66. Three switches included in the second switch circuit 66 are connected to a second resistor 70, a third resistor 71, and a fourth resistor 72, respectively, which are located outside of the semiconductor laser drive LSI 60. Accordingly, a resistor selected by the second switch circuit 66 is connected to an inverting input terminal of the third operational amplifier 65 and an output terminal of the third operational amplifier 65.

The inverting input terminal of the third operational amplifier 65 is connected to the cathode terminal of the first photodiode 25 and a cathode terminal of the third photodiode 281. Here, different from the example shown in FIG. 1, cathode terminals of the photodiodes are connected to the inverting input terminal of the third operational amplifier 65. Anode terminals of the first photodiode 25 and the third photodiode 281 are both connected to ground (GND), and a non-inverting input terminal of the third operational amplifier 65 is connected to a reference voltage Vref. In this way, the anode terminals of the first photodiode 25 and the third photodiode 281 are both connected to GND. Therefore, the same as in the case of the fourth semiconductor laser 28, even when the cathode terminal of the semiconductor laser device 283 and the anode terminal of the third photodiode 281 are united, the third photodiode 281 which is a back monitor can be used.

The second switch circuit 66 is configured by, for example, a field-effect transistor. According to a signal from the interface circuit 61, the second switch circuit 66 operates in conjunction with the first switch circuit 64 so as to be switched. That is to say, the second switch circuit 66 is connected to the second resistor 70 when laser power for BD is detected, to the third resistor 71 when laser power for DVD is detected, and to the fourth resistor 72 when laser power for CD is detected. When assuming values of the second resistor 70, the third resistor 71, and the fourth resistor 72 to be R2, R3, and R4, respectively, a relationship between an input current Iᵢₙ and an output voltage Vₒᵤₜ in the respective cases thereof is expressed by the following equation:

Vₒᵤₜ=V_{ref}−Iᵢₙ×Rn

wherein Rn is any one of R2, R3, and R4.

In this way, the second switch circuit 66 switches the second resistor 70, the third resistor 71, and the fourth resistor 72 which are used for current-voltage conversion. This is due to the difference in the relationships between output power of the respective semiconductor lasers and output current of photodiodes for laser power detection.

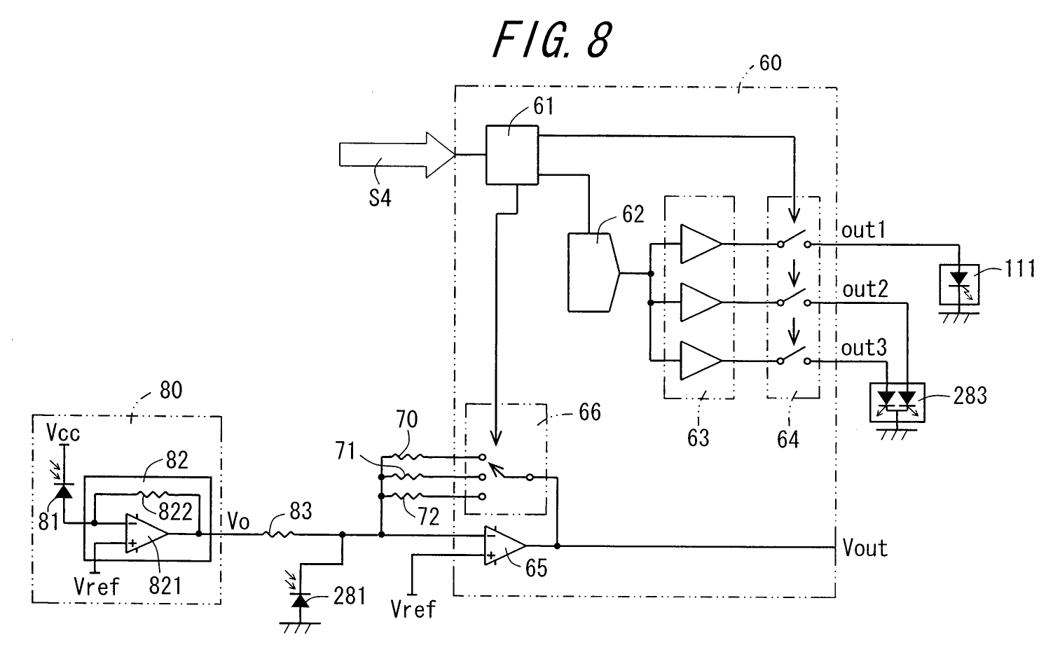

FIG. 8 is a view showing an example of circuit constitution where the first photodiode 25 shown in FIG. 7 is replaced with a fourth photodetector 80. In the fourth photodetector 80, a forth photodiode 81 and a fourth current-voltage conversion circuit 82 are molded so as to be housed into a single package.

The fourth current-voltage conversion circuit 82 includes a fourth operational amplifier 821 and a fifth resistor 822. The fifth resistor 822 is connected between an inverting input terminal of the fourth operational amplifier 821 and an output terminal of the fourth operational amplifier 821. An output signal V, of the fourth photodetector 80 is inputted, via a resistance element 83, to the inverting input terminal of the third operational amplifier 65 which constitutes the current-voltage conversion circuit inside the semiconductor laser drive LSI 60. After an output current signal of the fourth photodiode 81 is converted into a voltage signal Vₒ by the fourth current-voltage conversion circuit 82, the voltage signal Vₒ is converted into a current signal by the resistance element 83, and then the current is converted again into a voltage signal Vₒᵤₜ by the current-voltage conversion circuit inside the semiconductor laser drive LSI 60. A relationship between the output voltage Vₒ and the output signal Vₒᵤₜ of the fourth photodetector 80 is expressed by the following equation:

Vₒᵤₜ=−Vₒ×Rn/R5

Rn is a resistance value of a resistor selected by the second switch circuit 66 among the second resistor 70, the third resistor 71, and the third resistor 72. That is to say, Rn is a resistance value of a resistor selected among R2, R3, and R4 by the second switch circuit. R5 is a resistance value of the resistor 83. The same voltage signal is applied to a reference voltage V_{ref} inside the fourth operational amplifier 821 of the fourth current-voltage conversion circuit 82 and a reference voltage V_{ref} of the third operational amplifier 65 inside the semiconductor laser drive LSI 60.

In this way, the optical pickup 201 is provided with the semiconductor laser drive LSI 60 where a semiconductor laser driving circuit and a current-voltage conversion circuit are housed into the same package. The output terminals of the first photodiode 25 and the third photodiode 281 are connected to each other and are connected thereafter to the input terminal of the current-voltage conversion circuit inside the semiconductor laser drive LSI 60. Accordingly, it is possible to downsize a more sophisticated circuit for, for example, loading the second switch circuit 66 for switching sensitivity to the current-voltage conversion circuit of the semiconductor laser drive LSI 60. Consequently, the optical pickup 201 can be further downsized, and high performance of the optical pickup 201 can be achieved.

That is to say, the optical pickup 201 is provided with a high-density integrated circuit portion such as the semiconductor laser drive LSI 60. In the high-density integrated circuit portion, a plurality of driving circuits that drive respectively the aforementioned plurality of light sources, and the aforementioned current-voltage conversion circuit, are housed into the same package, and an input terminal is provided to the current-voltage conversion circuit. Also, the respective output terminals of the aforementioned plurality of light-detecting elements such as the fourth photodiode 81 and the third photodiode 281, are connected to the input terminal provided in the high-density integrated circuit portion. Consequently, this makes it possible to employ an existing low-price LSI where driving circuits and a current-voltage conversion circuit are housed into the same package. Accordingly, the cost of the optical pickup 201 can be reduced.

Further, in the fourth photodetector 80 are molded the fourth photodiode 81 and the fourth current-voltage conversion circuit 82, so light detection can be performed fast. And the cost can be reduced by using the fourth photodiode 81 of the fourth photodetector 80 and the third photodiode 281 provided in the fourth semiconductor laser 28. And further, the optical pickup 201 is provided with the fourth photodetector 80 where the fourth photodiode 81 and the fourth current-voltage conversion circuit 82 are housed into the same package. The output of the fourth photodetector 80 is inputted, via the resistance element 83, to the input terminal of the current-voltage conversion circuit inside the semiconductor laser drive LSI 60. Accordingly, compared with the case where photodiodes are used alone, this makes higher-frequency-band light detection possible. Also, this makes it possible to increase options of photodetectors to be used and improve further flexibility in designing the optical pickup.

That is to say, the optical pickup is provided with a photodetector such as the fourth photodetector 80, and a resistance element connected to an output terminal of this photodetector such as the resistor 83. In the photodetector, a light-detecting element and a current-voltage conversion circuit are housed into the same package, and the output terminal is provided to output voltage signals converted by the current-voltage conversion circuit. And the output terminal of the aforementioned photodetector is connected, via the aforementioned resistance element, to the input terminal provided in the aforementioned high-density integrated circuit portion such as the semiconductor laser drive LSI 60. Consequently, high frequency-band light detection can be performed. Accordingly, fast operation can be achieved. Further, with respect to power detection of two light sources, power of one light source is detected by means of the photodetector where the light-detecting element and the current-voltage conversion circuit are molded, while power of the other one is detected by means of the current-voltage conversion circuit provided in the laser package. Consequently, this enables the optical pickup to be downsized and cost reduction to be achieved.

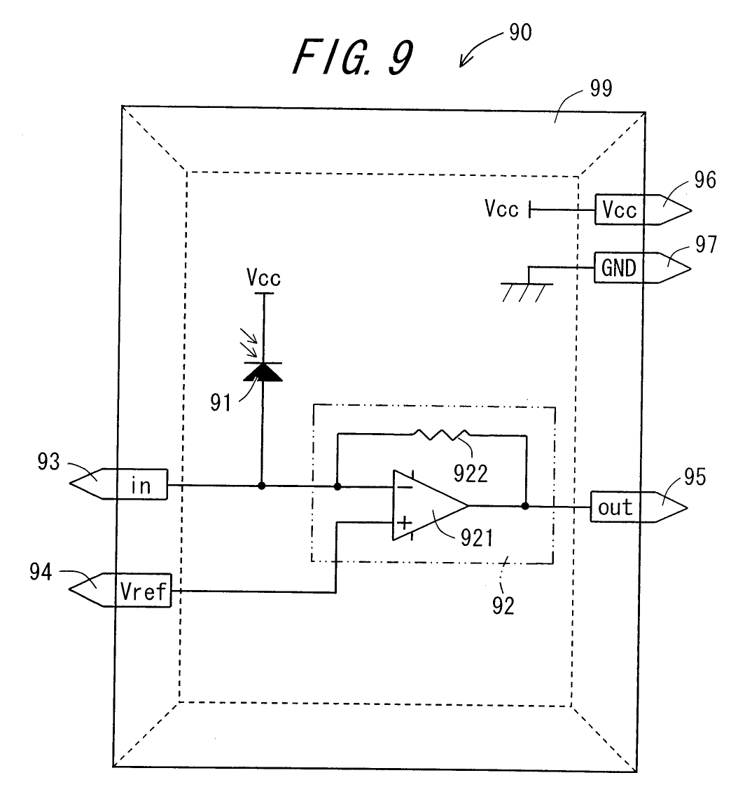

FIG. 9 is view showing a schematic constitution of a fifth photodetector 90 according to one embodiment of invention. The fifth photodetector 90 includes a fifth photodiode 91 and a fifth current-voltage conversion circuit 92 which are both housed into a package 99. The fifth current-voltage conversion circuit 92 is composed of a fifth operational amplifier 921 and a sixth resistor 922. The sixth resistor 922 is connected between an inverting input terminal of the fifth operational amplifier 921 and an output terminal of the fifth operational amplifier 921.

In the package 99 of the fifth photodetector 90 are provided an in-terminal 93 connected to the inverting input terminal of the fifth operational amplifier 921, a V_{ref} terminal 94 connected to a non-inverting input terminal of the fifth operational amplifier 921, an out-terminal 95 connected to the output terminal of the fifth operational amplifier 921, a V_{CC} terminal 96 for supplying a power supply voltage V_{CC}, and a GND terminal 97 for connecting to GND. The supply voltage V_{CC} supplied to the V_{CC} terminal 96, is also used for a power supply of the operational amplifier and a reverse bias of the fifth photodiode 91.

A reference voltage V_{ref} is connected to the V_{ref} terminal 94 connected to the non-inverting input terminal of the fifth operational amplifier 921. An anode terminal of the fifth photodiode 91, is connected to the in-terminal 93 connected to the inverting input terminal of the fifth operational amplifier 921, and is further connected to an output terminal of a non-illustrated outside photodiode. The sixth resistor 922 may be so configured as to connect the outside of the fifth photodetector 90, so that outside adjustment can be performed. Alternatively, an amplifier circuit may be further disposed after current-voltage conversion. The photodetector 90 may be so configured as to produce differential output.

In this way, the fifth photodetector 90 is configured in such a manner as the output terminal of the fifth photodiode 91 inside the package 99 and the inverting input terminal of the fifth operational amplifier 921 are connected to each other. Also, the fifth photodetector 90 is provided with the in-terminal 93 which is an input terminal for converting an input current signal from the outside photodiode into a voltage signal. Accordingly, with respect to a plurality of photodiodes, number of current-voltage conversion circuits can be reduced to one, when the fifth photodetector 90 is applied to the optical pickup 1 shown in FIG. 1 and the optical pickup 101 shown in FIG. 3. As a result, a downsized and low-cost pickup can be achieved with ease.

That is to say, a light-detecting element and a current-voltage conversion circuit 92 are housed into the same package. The light-detecting element, for example, the fifth photodiode 91, receives light and outputs a current signal corresponding to a power of the received light or laser power. The current-voltage conversion circuit 92, for example, the fifth current-voltage conversion circuit 92, converts the current signal into a voltage signal and outputs the voltage signal. And an input terminal, for example, the in-terminal 93, is provided to input a current signal. Also, the current signal outputted by the light-detecting element and the current signal inputted from the input terminal, are both inputted to the current-voltage conversion circuit. Consequently, higher frequency-band light detection can be performed, compared with a case where a light-detecting element is used alone without being combined with a current-voltage conversion circuit. And a current signal of the light-detecting element used alone, can be inputted from an input terminal and can be thereafter converted into a voltage signal. Accordingly, this makes it possible to apply one current-voltage conversion circuit to, both a light source of which fast operation is required and a light source of which fast operation may be not required, whereby the optical pickup can be downsized. That is to say, without deterioration in flexibility of an optical design where a plurality of light sources are used, it is possible to reduce the number of necessary current-voltage conversion circuits for controlling output power of the plurality of light sources.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. An optical pickup apparatus which performs at least either recording information on an information recording medium or reproducing information from an information recording medium, comprising:
a plurality of light sources;
a plurality of light-detecting elements which receive light emitted from the light sources, the plurality of light-detecting elements each having an output terminal for outputting a current signal corresponding to an intensity level of the received light; and
a current-voltage conversion circuit having an input terminal for inputting the current signal, the current-voltage conversion circuit converting the current signal inputted to the input terminal into a voltage signal so as to output the voltage signal,
wherein the output terminals of the plurality of light-detecting elements are connected to each other and are connected to the input terminal of the current-voltage conversion circuit.

2. The optical pickup apparatus of claim 1, wherein the plurality of light sources includes:
a first light source which emits light when recording and reproducing information are performed on or from the information recording medium; and
a second light source which emits light when only reproducing information is performed from the information recording medium,
the plurality of light-detecting elements includes:
a first light-detecting element which receives the light emitted from the first light source; and
a second light-detecting element which receives the light emitted from the second light source, and
the first light-detecting element and the second light-detecting element are arranged in such a manner that a length of a wiring path from an output terminal of the first light-detecting element to the input terminal of the current-voltage conversion circuit is shorter than a length of a wiring path from an output terminal of the second light-detecting element to the input terminal of the current-voltage conversion circuit.

3. The optical pickup apparatus of claim 1, further comprising:
a high-frequency cut-off element for cutting off a high-frequency signal having a frequency equal to a predetermined frequency value or higher,
wherein the plurality of light sources include:
a first light source which emits light when recording and reproducing information are performed on or from the information recording medium; and
a second light source which emits light when only reproducing information is performed from the information recording medium,
the plurality of light-detecting elements include:
a first light-detecting element which receives the light emitted from the first light source; and
a second light-detecting element which receives the light emitted from the second light source, and
an output terminal of the second light-detecting element is connected, via the high-frequency cut-off element, to an output terminal of the first light-detecting element and the input terminal of the current-voltage conversion circuit.

4. The optical pickup apparatus of claim 1, further comprising:
a high-density integrated circuit portion having an input terminal of the current-voltage conversion circuit, the high-density integrated circuit portion including a plurality of driving circuits for driving the plurality of light sources, respectively, and the current-voltage conversion circuit, the plurality of driving circuits and the current-voltage conversion circuit being housed in a same package,
wherein the input terminal formed in the high-density integrated circuit portion is connected to the respective output terminals of the plurality of light-detecting elements.

5. The optical pickup apparatus of claim 4, further comprising:
a photodetector including a light-detecting element and a current-voltage conversion circuit, the light-detecting element and the current-voltage conversion circuit being housed into a same package, the photodetector having an output terminal which outputs a voltage signal converted by the current-voltage conversion circuit; and
a resistance element connected to the output terminal of the photodetector,
wherein the output terminal of the photodetector is connected via the resistance element to the input terminal formed in the high-density integrated circuit portion.

6. A photodetector having an input terminal for inputting an current signal, comprising:
a light-detecting element for receiving light and outputting a current signal corresponding to an intensity of the received light; and
a current-voltage circuit for converting a current signal into a voltage signal and outputting the voltage signal,
the light-detecting element and the current-voltage circuit being housed into a same package,
wherein the current signal outputted from the light-detecting element and the current signal inputted from the input terminal are both inputted to the current-voltage conversion circuit.
